(19) United States
(12) Patent Application Publication
(10) Pub. No.: US 2018/0038325 A1
(43) Pub. Date: Feb. 8, 2018

(54) Fuel Pump Housing With An Integrated Deflector

(71) Applicant: Ford Global Technologies, LLC, Dearborn, MI (US)

(72) Inventors: Theodore Beyer, Canton, MI (US); Edna L. Richards, Sterling Heights, MI (US); Jonathan Robert Burns, Windsor (CA); Bryan McKeough, Macomb, MI (US); Robert S. Parker, Canton, MI (US)

(73) Assignee: Ford Global Technologies, LLC, Dearborn, MI (US)

(21) Appl. No.: 15/226,938

(22) Filed: Aug. 3, 2016

(51) Int. Cl. F02M 37/00; B60K 28/14; F02M 37/04

(52) U.S. Cl. CPC F02M 37/0011; F02M 37/043; B60K 28/14; F02M 2200/185

(57) ABSTRACT

Some gasoline engines have a high-pressure fuel pump that is driven by a rotating component of the engine such as the camshaft or crankshaft. In the event of a crash, the fuel lines coupled to the engine should remain intact to avoid fuel spillage. It is known in the prior art to provide a separate bracket to provide the protection. However, such bracket is a separate piece that must be separately assembled, coupled to components of the engine requiring mounting holes, and adds to the part count of the engine. By integrating a deflector with a fuel pump component, the bracket is obviated.

### FIELD

The present disclosure relates to deflectors for protecting engine components from crash damage, in particular fuel pump componentry.

### BACKGROUND

A highly-simplified illustration of a fuel system for a direct-injection engine is shown in FIG. 1. A 3-cylinder engine 10 has injectors 12 that provide fuel at high pressure into cylinders 14. Fuel is delivered to injectors 12 via a high pressure fuel rail 16 that branches off to individual cylinders 14. A high pressure pump 18, which is mechanically driven off engine 10 feeds rail 16. Fuel to pump 18 comes from fuel tank in which a low pressure fuel pump 22 is disposed. Pump 22 pressurizes fuel in fuel supply line 24. Additionally, pump 18 is electronically coupled to an electronic control unit 30.

In FIG. 2, a high pressure pump 40 is driven by a cam 44 that has four lobes and is part of a rotating component, camshaft 46. Alternatively, the rotating component is a crankshaft or suitable driver. A cup 48 has a roller 50 that rides on cam 44. A spring (not visible) is in the cup and pushes on a plunger (also not visible) in pump 40 to pressurize the fuel. Low pressure fuel enters through inlet 52 and high pressure fuel exits through outlet 54. A solenoid within pump 40 controls the portion of the plunger stroke that pressurizes fuel to provide the desired amount of fuel. The control signal wires couple at connector 58. Fuel inlet 52, fuel outlet 54 and electrical connector 58 should be protected in a crash. Pump 40 couples to a housing (not shown) via flange 58.

In FIG. 3, a portion of the under hood of a vehicle is shown. An engine compartment has a wall 82 (interface between engine compartment and passenger compartment) on which a brake booster 84 is coupled. A high-pressure fuel pump 86 with a high pressure fuel line 88 is also in engine compartment 82. During a crash, fuel pump 86 connections: high pressure fuel, low pressure fuel, and connector can collide with brake booster 84. Brake booster 84 is simply one example of a vehicle component. In other engine configurations and depending on packaging, the vehicle component that is proximate fuel pump 86 could be other than brake booster 84.

A high pressure pump 60 as installed on a cylinder head 62 of an engine 88 is shown in FIG. 4. Pump 60 has a high fuel pressure outlet tube 64, a low fuel pressure inlet coupling 65, and an electrical connector 66. Also shown is an intake duct 68 that runs aside pump 60. Not shown are other vehicle components in the vicinity of pump 60. In the event of a crash, vehicle components move around and might press into the space occupied by the fuel pump or even fly off into the fuel pump space. To avoid damage by other vehicle components, a deflector 70 is provided proximate pump 60. Deflector 50 is secured by multiple bolts 52, one of which is visible in FIG. 2. Material is included on other engine components to provide a threaded hole into which bolts 52 engage. The material to accommodate engine components increases vehicle weight. Furthermore, space is required under the hood to install the bolts holding the deflector in place.

### SUMMARY

To obviate a separate deflector that is coupled to the engine proximate the fuel pump, a fuel pump housing for an internal combustion engine is disclosed that includes: a fuel pump flange having defining an opening to accommodate a fuel pump and a deflector that is integral with the fuel pump housing. The deflector is provided around a portion of the periphery of the fuel pump flange and the deflector extends away from the fuel pump housing.

In embodiments where the fuel pump housing is a separate piece from the engine, the fuel pump housing includes an engine flange. The fuel pump housing can be coupled to the block or the cylinder head of the engine. The engine flange has a groove defined therein with an O-ring situated in the groove.

In some embodiments, at least one relief is provided in the fuel pump flange to thereby decrease weight of the fuel pump housing.

The deflector has rounded corners.

In some embodiments, the fuel pump housing is unitary with a cylinder head of an engine.

Also disclosed in an engine system having: an engine having a rotating component, a fuel pump housing coupled to the engine proximate the rotating component, and a fuel pump mounted onto the fuel pump housing. The fuel pump housing has an integral deflector that extends outwardly from the engine.

In some embodiments, the rotating component is a camshaft. The camshaft has a cam with at least one lobe for driving the fuel pump. The fuel pump has a plunger that is driven by the cam lobes to pressurize the fuel.

In other embodiments, the rotating component is a crankshaft that has a cam with a least one lobe for driving the fuel pump.

The engine system also has a fuel line coupled to the fuel pump. There is at least one accessory proximate the fuel pump. The deflector is provided on a flange of the fuel pump housing and the deflector is located between the accessory and the fuel pump.

The deflector comprises a wall with smooth bends.

The deflector is on the periphery of a flange of the fuel pump housing.

The deflector is integrally formed with a body of the pump.

In embodiments where the fuel pump housing is not integrally formed with an engine component, the fuel pump housing is coupled to one of the block and the cylinder head of the engine.

In other embodiments, the fuel pump housing is integral with the cylinder head.

Also disclosed in a vehicle having: an engine having a block and a cylinder head, a camshaft mounted in the cylinder head and having a plurality of cams, a fuel pump housing arranged proximate one lobe of the camshaft, and a fuel pump mounted onto the fuel pump housing. The engine is mounted in an engine compartment of the vehicle. The fuel pump housing has an integral deflector that extends outwardly from the one came of camshaft.

A vehicle component is mounted in the engine compartment

The integral deflector is located between the fuel pump and a vehicle component mounted in the engine compartment.

The fuel pump has fuel lines coupled to a low-pressure outlet and a high-pressure inlet. The integral deflector is disposed between a vehicle component mounted in the engine compartment and the high-pressure inlet and the low-pressure outlet.

The fuel pump housing has a flange onto which the fuel pump mounts. The flange has at least one relief to thereby reduce the mass of the fuel pump housing.

In some embodiments, the fuel pump housing is integral with the engine, either the cylinder head of the block.

The present disclosure describes obviating a separate deflector for crash protection of fuel pump connectors. By using an integrated deflector: part count is reduced (separate deflector and multiple bolts) and vehicle assembly is simplified. In the prior art, a number of bolts are inserted to secure the separate deflector, which affects packaging and assembly as the bolt holes must be accessible. Furthermore, provisions for the bolt holes in the engine or nearby accessories are required. This may necessitate adding material simply for the securing the deflector. An integral deflector overcomes all of the issues listed above.

### BRIEF DESCRIPTION OF THE DRAWINGS

FIG. 1 is an illustration of a direct-injection, spark-ignition engine showing the high-pressure fuel system;

FIG. 2 is an illustration of a high-pressure fuel pump;

FIG. 3 is a portion of a view in an engine compartment showing a vehicle component and a high-pressure fuel pump with a deflector according to the prior art;

FIG. 4 is an illustration of a portion of an engine and accessories with the high pressure fuel pump having a prior art deflector;

FIG. 5 shows a fuel pump housing with a deflector according to an embodiment of the disclosure;

FIG. 6 shows the fuel pump housing of FIG. 5 with a fuel pump installed on the housing and a camshaft extending into the fuel pump housing; and

FIG. 7 shows a fuel pump mounted in an engine compartment.

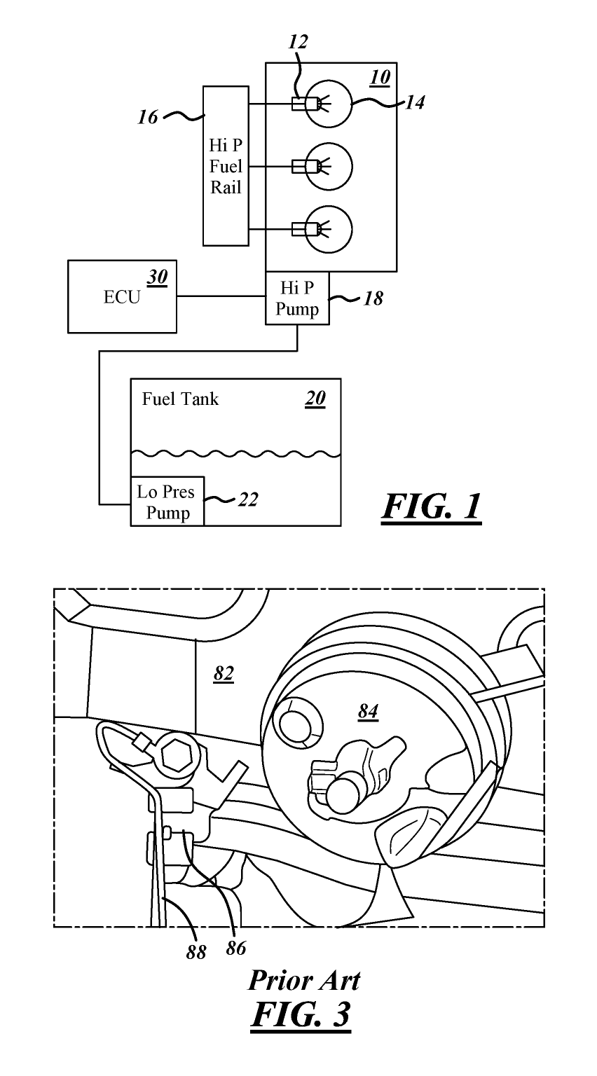

### DETAILED DESCRIPTION

As those of ordinary skill in the art will understand, various features of the embodiments illustrated and described with reference to any one of the Figures may be combined with features illustrated in one or more other Figures to produce alternative embodiments that are not explicitly illustrated or described. The combinations of features illustrated provide representative embodiments for typical applications. However, various combinations and modifications of the features consistent with the teachings of the present disclosure may be desired for particular applications or implementations. Those of ordinary skill in the art may recognize similar applications or implementations whether or not explicitly described or illustrated.

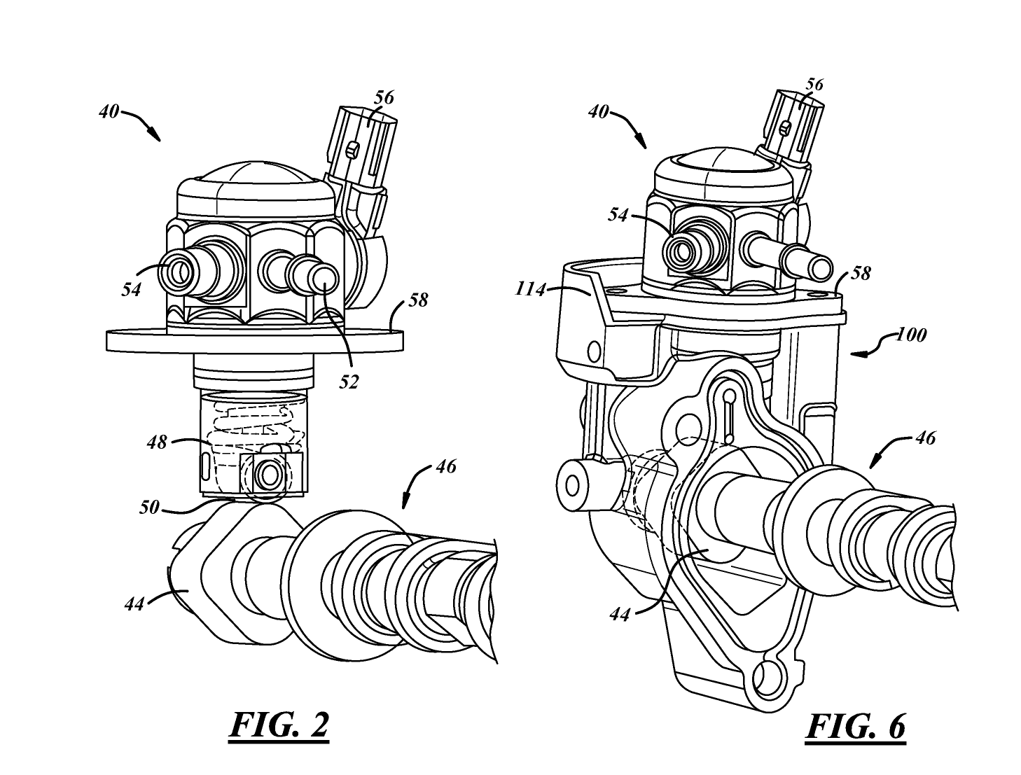

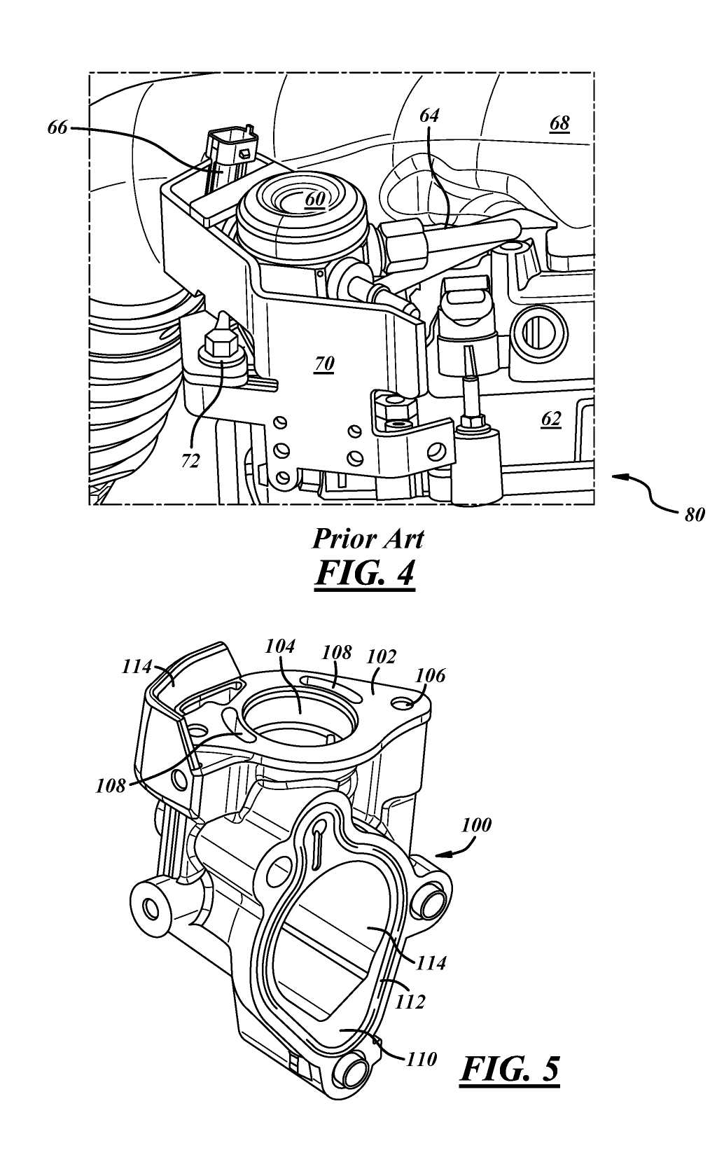

In FIG. 5, a fuel pump housing 100 has a flange 102 and an opening 104 that accommodates the fuel pump. The roller and cup of the fuel pump (such as shown in FIG. 2) are placed into opening 104. Bolts go through fuel pump and extend into threaded holes 106. Kidney shaped reliefs 108 are formed in flange 102 reduce the weight of housing 100. Relief 108 optional. A deflector 110 extends from flange 102 extending outwardly from fuel pump housing 100 or extending toward the outer portion of the fuel pump, as shown in a later drawing. In some embodiments, the fuel pump housing is integral with the cylinder head or the block. Deflector 110 is rounded so that in the event of a collision with a vehicle component, the vehicle component is deflected.

In FIG. 6, fuel pump 40 is shown assembled onto housing 100 with camshaft 46 extending out from housing 100.

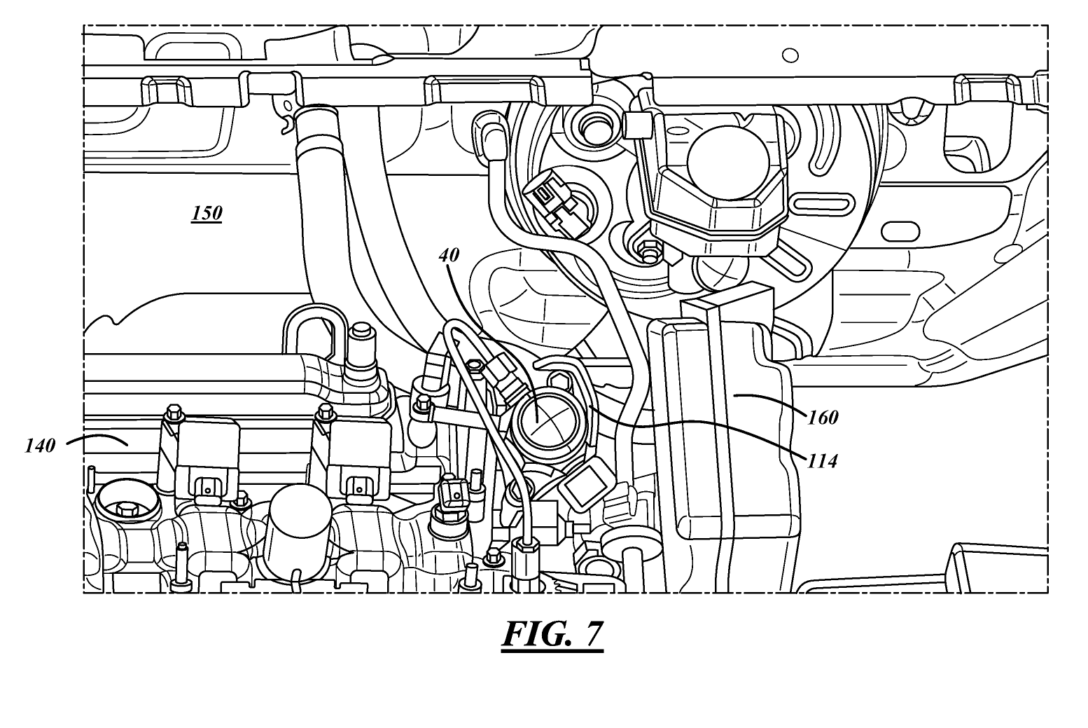

A view of a portion of an engine compartment is shown in FIG. 7. Some of the components of the engines are not shown so that the fuel pump is readily visible. A fuel pump 40 is coupled to an engine 140 that is provided air through an air filter box 160. The engine compartment has a wall 150 that separates the engine compartment from the passenger compartment. Hot coolant flows into the passenger compartment through wall 150 via coolant supply 152 when requested by a passenger. Coolant returns to the engine compartment via a coolant return 154. A brake booster 156 is coupled to wall 150. The fuel pump housing is largely unseen in FIG. 7; however, deflector 144, which is provided to protect the fuel and electrical connections, is seen between fuel pump 40 and brake booster 156.

While the best mode has been described in detail with respect to particular embodiments, those familiar with the art will recognize various alternative designs and embodiments within the scope of the following claims. While various embodiments may have been described as providing advantages or being preferred over other embodiments with respect to one or more desired characteristics, as one skilled in the art is aware, one or more characteristics may be compromised to achieve desired system attributes, which depend on the specific application and implementation. These attributes include, but are not limited to: cost, strength, durability, life cycle cost, marketability, appearance, packaging, size, serviceability, weight, manufacturability, ease of assembly, etc. The embodiments described herein that are characterized as less desirable than other embodiments or prior art implementations with respect to one or more characteristics are not outside the scope of the disclosure and may be desirable for particular applications.

1. An engine system, comprising:
an engine having a rotating component;
a fuel pump housing coupled to the engine proximate the rotating component; and
a fuel pump mounted onto the fuel pump housing wherein the fuel pump housing has an integral deflector that extends outwardly from the engine.

2. The engine system of claim 1 wherein:
the rotating component is a camshaft;
the camshaft has a cam with at least one lobe for driving the fuel pump; and
the fuel pump has a plunger that is driven by the at least one cam lobe to pressurize the fuel.

3. The engine system of claim 1 wherein:
the rotating component is a crankshaft that has a cam with a least one lobe for driving the fuel pump; and
the fuel pump has a plunger driven by the at least one cam lobe to pressurize the fuel.

4. The engine system of claim 1, further comprising:
a fuel line coupled to the fuel pump; and
at least one accessory proximate the fuel pump wherein the deflector is located between the accessory and the fuel pump.

5. The engine system of claim 1 wherein the deflector comprises a wall with smooth bends.

6. The engine system of claim 1 wherein the deflector is on the periphery of a flange of the fuel pump housing.

7. The engine system of claim 1 wherein the deflector is integrally formed with a body of the pump.

8. The engine system of claim 1 wherein the fuel pump housing is coupled to one of the block and the cylinder head of the engine.

9. The engine system of claim 1 wherein the fuel pump housing is integral with the cylinder head.

10. A fuel pump housing for an internal combustion engine, comprising:
a fuel pump flange defining an opening to accommodate a fuel pump; and
a deflector that is integral with the fuel pump housing wherein:
the deflector is provided around a portion of the periphery of the fuel pump flange and the deflector extends away from the fuel pump housing.

11. The fuel pump housing of claim 10, further comprising: an engine flange.

12. The fuel pump housing of claim 11 wherein the engine flange has a groove defined therein with an O-ring situated in the groove.

13. The fuel pump housing of claim 10 wherein at least one relief is provided in the fuel pump flange to thereby decrease weight of the fuel pump housing.

14. The fuel pump housing of claim 10 wherein the deflector has rounded corners.

15. The fuel pump housing of claim 10 wherein the fuel pump housing is unitary with a cylinder head of an engine.

16. A vehicle, comprising:
an engine having a block and a cylinder head;
a camshaft mounted in the cylinder head and having a plurality of cams;
a fuel pump housing arranged proximate one cam of the camshaft; and
a fuel pump mounted onto the fuel pump housing wherein:
the engine is mounted in an engine compartment of the vehicle; and
the fuel pump housing has an integral deflector that extends outwardly from the one cam of the camshaft.

17. The vehicle of claim 16 wherein:
a vehicle component is mounted in the engine compartment; and
the integral deflector is located between the fuel pump and the vehicle component.

18. The vehicle of claim 16 wherein:
the fuel pump has fuel lines coupled to a low-pressure outlet and a high-pressure inlet;
a vehicle component is mounted in the engine compartment; and
the integral deflector is disposed between the vehicle component and the high-pressure inlet and the low-pressure outlet.

19. The vehicle of claim 16 wherein:
the fuel pump housing has a flange onto which the fuel pump mounts; and
the flange has at least one relief to thereby reduce the mass of the fuel pump housing.

20. The vehicle of claim 16 wherein the fuel pump housing is unitary with one of a cylinder head of the engine and a block of the engine.
